(19) United States
(12) Patent Application Publication
(10) Pub. No.: US 2007/0281162 A1
(43) Pub. Date: Dec. 6, 2007

(54) BONDED CARBON FOAM ASSEMBLIES

(75) Inventor: Thomas M. Matviya, McKees Rocks, PA (US)

Correspondence Address: PHILIP D. LANE, P.O. BOX 79318, CHARLOTTE, NC, 28271-7063, US

(73) Assignee: TOUCHSTONE RESEARCH LABORATORY, LTD., Triadelphia, WV (US)

(21) Appl. No.: 11/421,844

(22) Filed: Jun. 2, 2006

(51) Int. Cl. B32B 9/00; C01B 31/02

(52) U.S. Cl. 428/408; 264/29.1; 156/325

(57) ABSTRACT

Assemblies or structures of carbon foam pieces connected with carbon char and methods for preparing such assemblies or structures are described. In certain embodiments an assembly may include two or more pieces of carbon foam bonded together by carbon char. The carbon char is derived from a carbonizable binder. A carbon foam assembly may be prepared by bonding at least one piece of carbon foam to at least one other piece of carbon foam with a carbonizable binder to provide an initial carbon foam assembly, and carbonizing the carbonizable binder of the initial carbon foam assembly to produce a carbon char and provide a carbon foam assembly.

### BRIEF SUMMARY OF THE INVENTION

Assemblies or structures of carbon foam pieces connected with carbon char and methods for preparing such assemblies or structures are described. In certain embodiments an assembly may include two or more pieces of carbon foam bonded together by carbon char. The carbon char is derived from a carbonizable binder. The carbonizable binder may comprise phenolic resins, resorcinol resins, furan resins, pitch, tars, asphalt, bitumins, mesophase pitch, mesophase carbon, thermosetting polymers, lignosulfonates, graphite adhesives, coking coals, solvent refined coals, coal extracts, solvent refined coal byproducts, hydrogenated coals, and/or hydrogenated coal byproducts. In some embodiments, the carbon foam may have a density ranging from about 0.05 g/cc to about 1.5 g/cc. Further, the carbon foam of the assembly may have a compressive strength ranging from about 50 p.s.i. to about 12,000 p.s.i., or more. Still further, the assembly may include carbon foam having a coated surface.

In some embodiments, a carbon foam assembly may be prepared by bonding at least one piece of carbon foam to at least one other piece of carbon foam with a carbonizable binder to provide an initial carbon foam assembly, and carbonizing the carbonizable binder of the initial carbon foam assembly to produce a carbon char and provide a carbon foam assembly.

### BRIEF DESCRIPTION OF THE DRAWINGS

FIG. 1 provides an illustration of an assembly in accordance with an embodiment of the invention.

FIG. 2 provides an illustration of an assembly in accordance with another embodiment of the invention.

FIG. 3 provides an illustration of an assembly in accordance with yet another embodiment of the invention.

FIG. 4 provides an illustration of an assembly in accordance with a further embodiment of the invention.

### DETAILED DESCRIPTION OF EMBODIMENTS OF THE INVENTION

Carbon foam assemblies and a method for the production of such carbon foam assemblies are described. In certain embodiments, carbon foam assemblies may be characterized in that they are comprised of two or more pieces of carbon foam bonded together by carbon char derived from a carbonizable binder. Where such bonding occurs, at least one carbon foam piece is at least intermittently bonded by carbon char, derived from a carbonizable binder, to at least one other piece of carbon foam.

The three dimensional shapes of the carbon foam assemblies may encompasses elements of any classical geometric shape in any combination, including those in combination with non-classical shapes or irregular surfaces. Additionally, the three dimensional shape of the carbon foam assemblies may include those shapes having interior volumes wherein the interior volume surface of the carbon foam assembly is continuous with the outer surface of the carbon foam assembly. That is, in some embodiments, the interior volume is not completely enclosed by carbon foam but has at least one area open to the volume surrounding the carbon foam assembly. In other embodiments, the three dimensional shape of the carbon foam assemblies may include those shapes having interior volumes wherein the interior volume surface of the carbon foam assembly is not continuous with the outer surface of the carbon foam assembly. That is, in certain embodiments, the interior volume is completely enclosed by carbon foam. Carbon foam assemblies may be used, for example, as enclosures, supports, structural elements, decorations, composite tool bodies, molds, panels, and the like.

In some embodiments, carbon foam assemblies may be prepared by at least intermittently bonding at least one piece of carbon foam to at least one other piece of carbon foam by use of a carbonizable binder to produce an initial carbon foam assembly. The carbonizable binder of the initial carbon foam assembly is subsequently carbonized to produce a carbon char to provide an embodiment of a carbon foam assembly.

The carbon foam may be any carbon foam. Such carbon foams may be produced using any known feedstock and associated processes. The carbon foam may be produced, for example, from pitches, mesophase carbon, coal, coal extracts, coal derivatives, hydrogenated coal, hydrogenated coal extracts, carbonizing polymeric resins, and the like, using known carbon foam production procedures. The carbon foam may exhibit a bulk density ranging from about 0.05 g/cc to about 1.5 g/cc. In some embodiments, the carbon foam may exhibit a bulk density ranging from about 0.1 g/cc to about 0.8 g/cc. Further, the carbon foam may exhibit compressive strengths ranging from about 50 p.s.i. to about 12,000 p.s.i., or greater. In some embodiments, the carbon foam may exhibit compressive strengths ranging from about 150 p.s.i. to about 10,000 p.s.i. Other properties of the carbon foam may include thermal conductivities ranging from about 0.05 W/mK to about 0.4 W/mK.

The carbonizable binder may be a composition or material, that when applied to the joining surfaces of the carbon foam, produces a significant yield of carbon char upon carbonization. In some embodiments, the carbon char derived form the carbonizable binder is a strong, cohesive, carbon material that is continuous over at least short distances. In other embodiments, the carbon char may exhibit a carbon structure that is not continuous. For example, in some embodiments, grain boundaries in the carbon char may clearly evident. In still other embodiments, upon magnified inspection, the visible structure of the carbon comprising both the carbon foam and the carbon char may be non-continuous with boundaries between them clearly evident. In some embodiments, the amount of carbon derived from the carbonizable binder (i.e. char yield) is of sufficient quantity, and possesses sufficient cohesion, to provide a strong bond between the pieces of carbon foam comprising the carbon bonded carbon foam assembly.

Curing or drying of the carbonizable binder may be necessary to develop maximum bond strength between the pieces of carbon foam prior to carbonization. The carbonizable binder may be dissolved in or wet with a solvent. Suitable carbonizable binders may comprise, but are not limited to, phenolic resins, resorcinol resins, furan resins, pitch, tars, asphalt, bitumins, mesophase pitch, mesophase carbon, thermosetting polymers, lignosulfonates, graphite adhesives, coking coals, solvent refined coals, coal extracts, solvent refined coal byproducts, hydrogenated coals and associated byproducts, and other similar materials. Some carbonizable binders may be used in combination with other carbonizable binders. Comminuted graphite, coal, coke, carbon foam and the like, for example, may be combined with some carbonizable binders to increase the resulting char yield of the binder. Comminuted filler materials, including but not limited to, ceramics, metals, and the like, may be dispersed in the carbonizable binder. The carbonizable binder may comprise other materials. These other materials typically do not contribute any significant amount of carbon or other solid material to the carbonized carbonizable binder. The function of these other materials may be to provide for additional bond strength in the assembly prior to carbonization of the binder. Such other materials may include, but are not limited to, non-carbonizing commercial adhesives, non-carbonizing polymers, cellulose based materials, and the like, whether used neat or solvated.

The carbonizable binder may be liberally applied to all portions of the joining edges or surfaces of the carbon foam pieces where mutual contact occurs or is desired. In certain embodiments, the carbonizable binder may be applied along the length of the bonding, or joining lines, or joining surfaces between the carbon foam pieces. In some embodiments, a sufficient quantity of carbonizable binder may be applied to the contacting surfaces to provide for good contact between the binder on opposing surfaces. The carbonizable binder, depending on desired type and formulation, may be applied as a comminuted dry material, as a paste, as a slurry, or as a, typically viscous, liquid material, mixture, or solution. In the case of carbonizable binder slurries or liquids, pre-wetting of the carbon foam mutual contacting surfaces, with a miscible solvent, or the same liquid as used to produce the slurry or solution, may aid in application and provide for a more uniform distribution of the binder. Partially or fully filling the cells of the carbon foam pieces at the contacting surfaces with the carbonizable binder may provide for stronger bonds. For those carbonizable binders at least partially comprised of a solid material, the particles size of the solid material may be smaller, even to orders of magnitude smaller, than the cell size of the carbon foam. Bond strength between the carbon foam sections may be improved if contact between the carbon foam of the opposing pieces contacting surfaces is essentially maintained after application of the carbonizable binder.

In some embodiments, the carbonizable binder exhibits a bond strength sufficiently strong so as to maintain the bond(s) between the carbon foam pieces of the initial carbon foam assembly during routine handling and heating of the binder to carbonization temperatures. If such strength is lacking, or as desired, the bonded carbon foam pieces of the initial carbon foam assembly may be secured in the desired orientation(s) with clamps and other such retaining devices. Such retaining devices may be comprised of materials that can tolerate the elevated temperatures to which the initial carbon foam assembly may be subjected to convert the carbonizable binder to carbon char. Such retaining devices may have a coefficient of thermal expansion substantially similar to that of the carbon foam.

The bonded carbon foam sections of the initial carbon foam assembly may also be secured in the desired orientation(s) by gravity and/or design of the mutually contacting surfaces of the carbon foam sections. Such designs for joining the carbon foam pieces may encompass those that are common to the carpentry arts. For example, butt joints, lap joints, dovetail joints, tongue and grove joints, mortise joints, V-groove joints, and the like can all be used, in combination with the carbonizable binder, to join carbon foam pieces together. Such methods may result in strong bonding between the pieces of carbon foam and appreciable strength in the resulting carbon bonded assembly.

In some embodiments, the carbonizing adhesive may only penetrate a joining surface of the carbon foam to a relatively shallow depth. As such, for example, lap and butt joints between sections of carbon foam may show good resistance to shear forces but relatively low resistance to tensional forces. Alternatively, other joints such as, for example, tongue and grove joints, mortise joints, and dovetail joints may show good resistance to both shear and tensional forces. Therefore, in some embodiments, joints designs providing good resistance to both shear and tensional forces may be preferred.

The size and shape of the carbon foam pieces to be bonded together to form the assemblies of the present invention are not particularly limited. Carbon foam pieces having a desired shape for incorporation into an assembly may be machined from larger pieces of carbon foam. Alternatively, carbon foam pieces having a desired shape for incorporation into an assembly may be produced from a carbon foam feedstock in a suitably shaped mold. Alternatively, carbon foam pieces having shapes not particularly related to the desired carbon foam assembly may be bonded together using a carbonizable adhesive to provide an initial carbon foam assembly. The dimensions of such an initial carbon foam assembly are inclusive of those of the desired carbon foam assembly. Such an initial carbon foam assembly may be machined prior to or after carbonization of the carbonizable binder to provide the desired carbon foam assembly.

The densities of the carbon foam pieces to be bonded together are also not particularly limited. For example, a piece(s) of a higher density carbon foam may be bonded to or in a piece(s) of a lower density carbon foam. Such combinations of foams of differing densities may provide, for example, for a stronger localized section(s) of the assembly(s). Such stronger localized sections may then provide, for example, for wall anchor points, localized impact protection, and/or structural support, and the like.

Once the carbon foam sections are at least intermittently bonded together using the selected carbonizable binder, the binder is carbonized by heating to elevated temperatures. Heating may be performed after the carbonizable binder has cured or dried, if necessary. Such heating serves to progressively carbonize the carbonizable binder to produce a carbon material that may be coherent and bonds the sections of carbon foam in a desired orientation to provide an embodiment of a carbon foam assembly. Such heating may also further carbonize the carbon foam of the assembly.

If the dimensions of the as-produced carbon foam assembly are not within the tolerances desired, the carbon of the assembly may be machined to the desired dimensions. Machining may be accomplished by the use of conventional methods. Carbide tooling may be used for such machining.

The method used to heat the carbonizable binder to effect carbonization of the binder is not particularly limited. Typically, the entire initial carbon foam assembly is heated to effect carbonization of the binder. Preferably the heating of the carbonizable binder to effect carbonization is conducted at a heating rate such that cracking, warping, and breakage of the carbon comprising the assembly does not occur. Preferably, heating of the assembly is conducted in a non-reactive, oxygen free, or otherwise inert atmosphere. Likewise, cooling of the resultant carbon foam assembly is preferably conducted in a non-reactive, oxygen free, or otherwise inert atmosphere until the carbon temperature is minimally less than about 400° C. and more preferably less than about 150° C. Such heating may be conducted in conventional industrial-like ovens and furnaces capable of maintaining controlled atmospheres and temperatures.

Heating of the assembly to a maximum desired elevated temperature may be conducted in a continuous manner. Alternatively, such heating may be conducted as a series of steps performed in one or more pieces of heating equipment. For example, the assembly may be heated in one type of furnace to carbonize the binder and heated in another type, or types, of furnace to further carbonize the binder. As an alternative example, the assembly may be heated to carbonize the carbonizable binder, and further heated, even to graphitization temperatures, in a single furnace.

As discussed herein, carbonization of the carbonizable binder may be considered to initiate at temperatures greater than about 200° C. and less than about 700° C. and may be further conducted at temperatures greater than about 700° C., even to temperatures as great as about 3200° C. or more. Graphitization temperatures are a subset of the range of carbonization temperatures and usually are considered to extend from about 1700° C., up to about 3200° C. or higher. The strength and electrical conductivity of the carbon foam assembly may increase with respect to the maximum temperature to which the carbon has been exposed, typically during preparation. In some embodiments, the assembly may be heated to minimally about 900° C. to ensure the carbon, of both the carbon foam and that derived from the carbonizable binder, exhibits sufficient strength to provide a durable assembly. Heating the assembly to temperatures greater than about 1000° C. may be advantageous. If desired, the resultant carbon foam assembly may be heated to temperatures as great as 3200° C. or more.

Alternatively, the carbonizable binder may be carbonized without the heating of the entire carbon foam assembly. Such heating may be accomplished by the application of heat to the carbon foam of the assembly in only those areas or volumes essentially contacting or surrounding the carbonizable binder. Such localized heating could potentially be accomplished by localized application of relatively high energy heat sources such as gas burners, radiant heaters, resistive heaters, and the like to the outer surface(s) of the carbon foam volume in closest proximity to the carbonizable binder. In some embodiments, the carbon foam essentially surrounding the carbonizable binder may be electrically conductive. Therefore resistive heating this carbon foam, by directing an electric current through the foam, to sufficient temperatures may result in the carbonization of the neighboring carbonizable binder. In certain other embodiments, the carbon foam essentially surrounding the carbonizable binder may interact with microwaves and/or inductive fields. In such an embodiment, the carbon foam assembly may be heated in only those areas or volumes essentially contacting or surrounding the carbonizable binder by the directed application of microwave energy or an inductive field. As was discussed above, heating and cooling, even of localized areas, of the assembly may be conducted in a non-reactive, oxygen free, or otherwise inert atmosphere.

The surface of the carbon foam assembly may be surfaced coated, covered, or faced with other materials using conventional methods. These other materials may extend from the assembly. Such other materials may provide, for example, additional assembly strength, bracing, waterproofing, impact resistance, and the like. Such other materials may include, but are not limited to, carbon foam, fiberglass, thermosetting and thermoplastic polymers, polymeric composites, carbon composites, paint, ceramics, wood, paper, metals, metal composites, and the like. Such other materials may be applied, for example, by dipping, spraying (including thermal spraying), hand lay-up methods, painting, gluing, mechanical fasteners, deposition (including chemical vapor deposition and vacuum deposition), and the like. The carbon foam of the assembly may also be impregnated with thermosetting or thermoplastic polymers, ceramics, and the like. Such impregnation may provide for additional assembly strength, bracing, waterproofing, impact resistance, and the like. Interior or exterior supports may be affixed to the carbon foam assembly. Such supports may be comprised of any solid material having sufficient strength to provide additional support to the carbon foam of the assembly. Such solid materials may include, but are not limited to, wood, solid polymers, composites, metals, and carbon foam. The carbon foam assemblies of the present invention may be incorporated into other assemblies.

The carbon foam assemblies may be used in many of the numerous applications for which conventional assemblies find utility. The use of carbon foam provides these carbon foam assemblies with differentiated beneficial properties which may make such assemblies particularly suitable in a number of specific applications. Additionally, the carbon foam comprising the assemblies of the present invention is bonded with carbon, derived from the carbonizable binder, rather than with conventional adhesives. Such carbon bonding can provide the assemblies of the present invention with the tolerance to extreme temperatures, chemical inertness, and electrical conductivity typically associated with carbon materials in general and carbon foam materials in particular. As such, the assemblies of the present invention may be used in applications where carbon foam assemblies of the prior art may be unsuitable. Such applications may include, but are not limited to: enclosures, supports, thermal shields, structural elements, decorations, composite tool bodies, molds, impact shields, panels, filters, and the like.

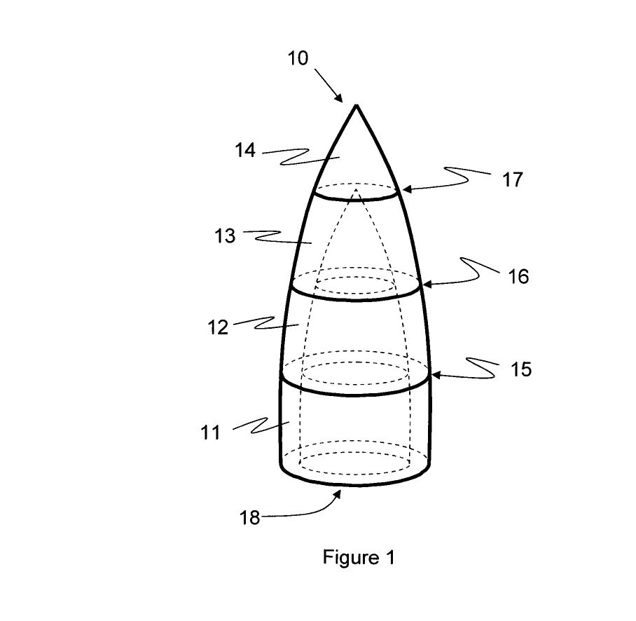

With reference now to FIG. 1, there is illustrated a carbon foam assembly 10 in accordance with an embodiment of the invention. The carbon foam assembly 10 may be comprised of four pieces of carbon foam. One of these carbon foam pieces 11 has a shape resembling a hollow cylinder. Two other pieces of the carbon foam 12 and 13 resemble hollow frustums. The fourth piece of carbon foam 14 resembles a cone. These four pieces of carbon foam are arranged in the assembly as illustrated. The carbon foam pieces are joined to neighboring pieces of carbon foam by carbon 15, 16, and 17 derived from a carbonizable binder. A portion of the interior volume 18 of the assembly is hollow.

Such an assembly may be prepared by a number of specific methods. For example, sections of carbon foam may be machined to provide pieces of carbon foam having the shapes of the carbon foam pieces of the carbon foam assembly. Alternatively, pieces of carbon foam may be cast, molded, or otherwise produced in the desired shape(s) and size(s). One produced, such pieces of carbon foam may be joined using a carbonizable binder to form an initial carbon foam assembly. Carbonizing of the carbonizable binder results in a carbon foam assembly of the present invention. The carbon foam may undergo an initial exposure to some carbonization temperatures simultaneously with the carbonizable binder. As desired, the resultant carbon foam assembly may be machined to final shape and/or dimensions.

Another method by which such a carbon foam assembly may be produced does not require the forming of individual carbon foam pieces to specific shapes. For this embodiment, the sections of carbon foam flat sheets are bonded together using a carbonizable binder to provide an initial carbon foam assembly having an internal volume capable of encompassing the desired carbon foam assembly. Prior to carbonization of the carbonizable binder, the assembly of flat carbon foam sheets may be machined or otherwise shaped to provide the initial carbon foam assembly. Alternatively, the carbonizable binder binding the flat carbon foam sheets may be carbonized. The carbon foam may undergo exposure to elevated carbonization temperatures simultaneously with the carbonizable binder. The resulting carbon foam assembly may then be machined or otherwise shaped to provide the desired carbon foam assembly.

The surface of the resulting carbon foam assembly may be fully or partially coated, covered, or faced with other materials as discussed previously. Also, the carbon foam may be fully or partially impregnated with thermosetting or thermoplastic polymers, ceramics, metals, and the like as has also been previously discussed.

A carbon foam assembly such as that illustrated in FIG. 1 or similar thereto may have many utilities. For example, such an assembly may be incorporated in a rocket nose cone. In such an application, the carbonizable binder of the carbon foam assembly may be carbonized at high temperatures to accentuate the strength and high temperature stability of the carbon foam assembly. Alternatively, such an assembly may comprise an artillery shell impact or thermal shield. The specific requirements of such an application would determine the most favorable carbonization temperature for the carbonizable binder and carbon foam of the assembly.

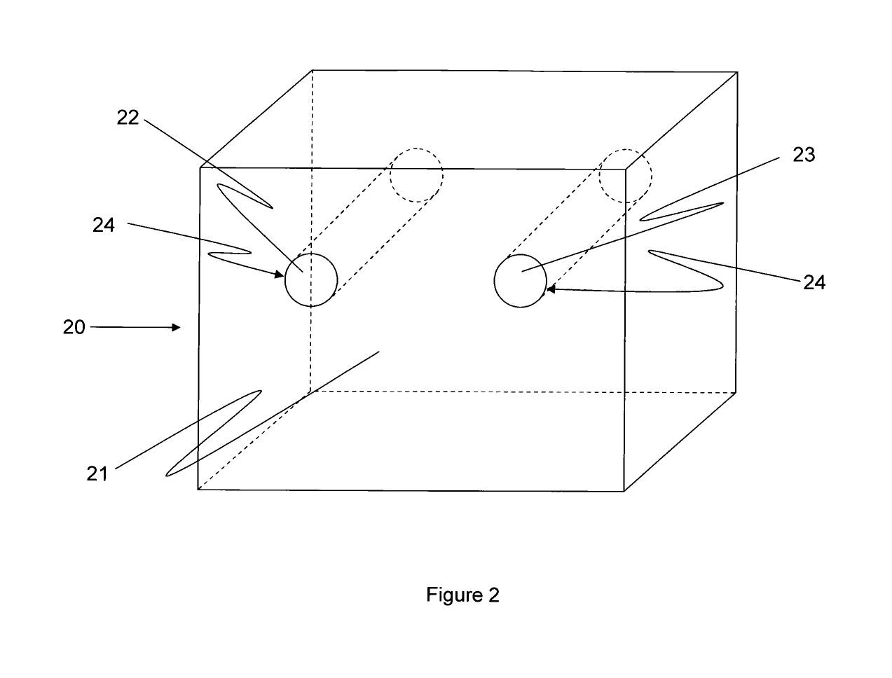

Turning now to FIG. 2, there is illustrated another embodiment of a carbon foam assembly 20. The carbon foam assembly 20 is comprised of three pieces of carbon foam. One of the pieces of carbon foam 21 is a rectangular piece of carbon foam of a given density. This rectangular piece of carbon foam has two through holes. Carbon foam cylinders 22 and 23, also having a density, are secured in each of these holes by carbon derived from a carbonizable binder at their respective joining surfaces 24.

The densities of the carbon foam pieces may be equivalent or different. Any differences in densities between the carbon foam pieces will be evident in the resulting carbon foam assembly. Such differences can provide specific utilities to the carbon foam assembly. For example, if the densities of the cylindrical carbon foam pieces are greater than that of the rectangular carbon foam piece, the resulting carbon foam assembly will have localized volumes of higher density carbon foam. The higher density carbon foam would be expected to be stronger and more thermally and electrically conductive than is the lower density carbon foam. Such localized sections of higher density carbon foam may then provide for improved localized heat or electrical transport through the carbon foam assembly. Such higher density carbon foam sections may also increase the strength of the carbon foam assembly. Additionally, such higher density/higher strength carbon foam may provide areas of higher strength in the assembly suitable for use with mechanical fasteners. Such mechanical fasteners may then be used for attachment of the carbon foam assembly to other materials or assemblies.

Alternatively, the densities of the cylindrical carbon foam pieces may be less than that of the rectangular polymeric piece resulting in a carbon foam assembly having localized volumes of lower density carbon foam. As carbon foam density decreases, the resistance to fluid flow through the carbon foam generally decreases. Therefore the inclusion of lower density carbon foam volumes in the carbon foam assembly may provide improved fluid transfer paths through the carbon foam assembly.

As was discussed above, the surface of the carbon foam assembly may be fully or partially coated, covered, or faced with other materials as discussed previously. Also, the carbon foam may be fully or partially impregnated with thermosetting or thermoplastic polymers, ceramics, metals, and the like as has also been previously discussed.

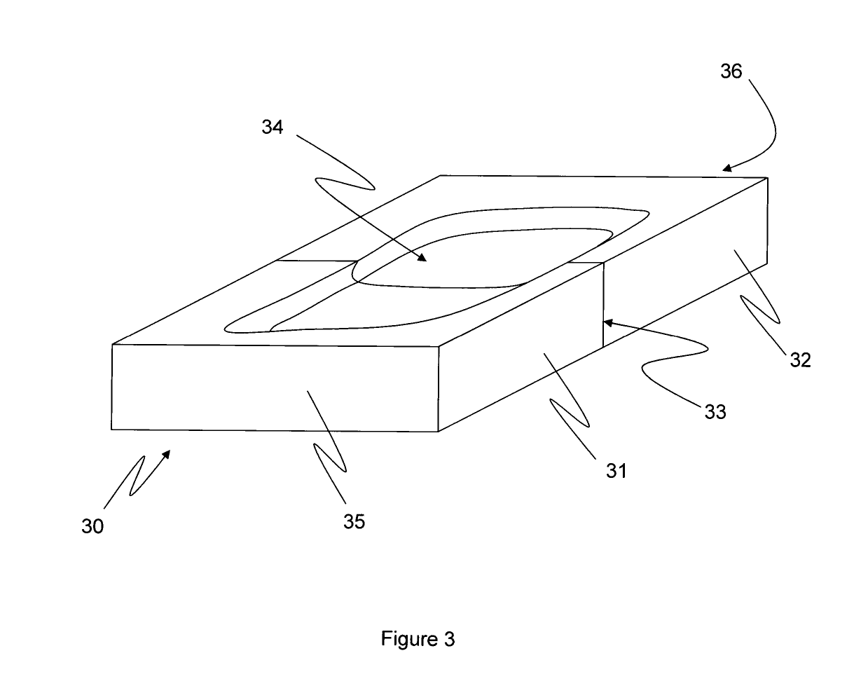

FIG. 3 illustrates a further embodiment of a carbon foam assembly 30. The carbon foam assembly 30 is comprised of two pieces of carbon foam 31 and 32. The two pieces of carbon foam 31 and 32 are bonded together at their mutual joining surfaces 33 by carbon derived from a carbonizable binder. The carbon foam assembly has a depression 34 on its top surface. Such a carbon foam assembly may be prepared from pieces of carbon foam bonded together using a carbonizable binder. The carbonizable binder may be carbonized, to provide a carbon foam assembly. The carbon foam may undergo initial exposure to elevated carbonization temperatures simultaneously with the carbonizable binder. The depression in the top surface of the carbon foam assembly may be machined in the carbon foam after carbonization. Optionally, the depression may be machined in the initial carbon foam assembly prior to carbonization of the carbonizable binder. Alternatively, the carbon foam pieces may be machined or cast in a suitable mold, prior to bonding to form the initial assembly, to provide for the top surface depression.

The surface of the carbon foam assembly may be coated, covered, or faced with other materials. The carbon foam may be impregnated with thermosetting or thermoplastic polymers, ceramics, metals, and the like as has also been previously discussed.

The carbon foam assembly of FIG. 3 may comprise a portion of a tool body for the forming of composite materials. In this example, the depressed top surface of the carbon foam assembly could be used as a tool face or support other materials that comprise a tool face for the forming of composite materials into composite parts. Carbonizing of the carbon foam assembly at a suitably high temperature may result in a carbon foam assembly having appreciable electrical conductivity. Therefore attaching suitable electrodes to opposite faces 35 and 36 of the assembly may provide for the passage of an electric current through a carbon foam assembly carbonized at a suitable elevated temperature. The passage of electric current through the carbon foam assembly can lead to resistive heating of the assembly. This resistive heating may in turn heat the composite materials on the tool face which may reduced curing times and result in more rapid composite part production.

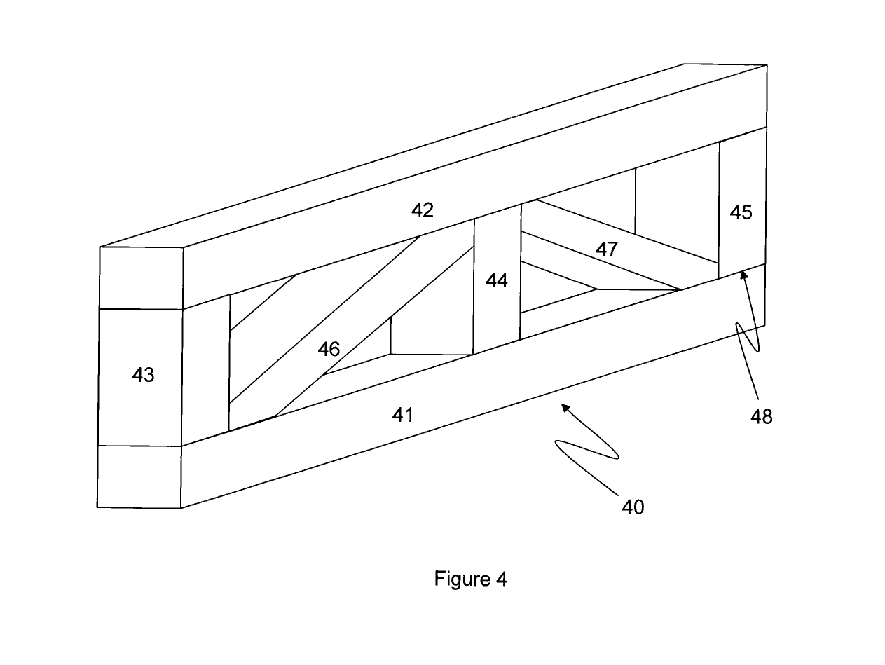

FIG. 4 illustrates an example of yet another embodiment of a carbon foam assembly 40. The carbon foam assembly 40 is comprised of seven pieces of carbon foam 41, 42, 43, 44, 45, 46, and 47 bonded together by carbon at their joining surfaces derived from a carbonizable binder to form a strut-like assembly, one such section represented by the numeral 48.

Such a carbon foam assembly may be prepared from pieces of carbon foam bonded together using a carbonizable binder. The carbonizable binder of the resulting initial carbon foam assembly may be carbonized to provide a carbon foam assembly. The carbon foam may undergo initial exposure to elevated carbonization temperatures simultaneously with the carbonizable binder. For applications where such an assembly would be utilized for load-bearing purposes, the assembly may be carbonized at the maximum temperature achievable with the available furnace(s). In some embodiments, such a maximum temperature is greater than about 1000° C.

The surface of the resulting carbon foam assembly may be surfaced coated, covered, or faced with other materials. The carbon foam may be impregnated with thermosetting or thermoplastic polymers, ceramics, metals, and the like as has also been previously discussed. As was also discussed previously, the carbon foam assembly may be machined to desired dimensions.

The strut-like assembly illustrated in FIG. 4 may be used, for example, either alone or incorporated in other assemblies for load-bearing purposes. The tolerance of carbon foams to high temperatures, especially under inert atmospheres, makes such assemblies especially useful in high temperature applications. Carbon foams are also relatively chemically unreactive. Therefore such assemblies may have utilities in harsh environments.

Several embodiments of the invention have been described in detail to provide an understanding of various aspects of the invention. The invention is not limited by these particular embodiments and can have a wide range of embodiments. The invention is only limited by the appended claims.

What is claimed is:

1. An assembly, comprising at least two pieces of carbon foam bonded together by carbon char.

2. The assembly of claim 1, wherein the carbon char is derived from a carbonizable binder.

3. The assembly of claim 2, wherein the carbonizable binder comprises at least one of the group comprising phenolic resins, resorcinol resins, furan resins, pitch, tars, asphalt, bitumins, mesophase pitch, mesophase carbon, thermosetting polymers, lignosulfonates, graphite adhesives, coking coals, solvent refined coals, coal extracts, solvent refined coal byproducts, hydrogenated coals, and hydrogenated coal byproducts.

4. The assembly of claim 1, wherein said carbon foam has a density ranging from about 0.05 g/cc to about 1.5 g/cc.

5. The assembly of claim 1, wherein said carbon foam has a compressive strength ranging from about 50 p.s.i. to about 12,000 p.s.i.

6. The assembly of claim 1, wherein at least one of said at least two pieces of carbon foam has a coated surface.

7. A method for producing a carbon foam assembly, comprising the steps of:
bonding at least one piece of carbon foam to at least one other piece of carbon foam with a carbonizable binder to provide an initial carbon foam assembly; and
carbonizing the carbonizable binder of the initial carbon foam assembly to produce a carbon char and provide a carbon foam assembly.

8. The method of claim 7, wherein the step of carbonizing the carbonizable binder further comprises heating the carbonizable binder to a temperature above about 700° C.

9. The method of claim 7, wherein said carbonizable binder comprises phenolic resin.

10. The method of claim 7, wherein said carbonizable binder comprises resorcinol resin.

11. The method of claim 7, wherein said carbonizable binder is selected from the group consisting of furan resins, pitch, tars, asphalt, bitumins, mesophase pitch, mesophase carbon, thermosetting polymers, lignosulfonates, graphite adhesives, coking coals, solvent refined coals, coal extracts, solvent refined coal byproducts, and hydrogenated coals.
